(19) United States
(12) Patent Application Publication
(10) Pub. No.: US 2003/0129944 A1
(43) Pub. Date: Jul. 10, 2003

(54) System and method of monitoring and controlling a remote device

(76) Inventors: Matthew C. T. Chang, Temecula, CA (US); James W. Frederick, Temecula, CA (US)

Correspondence Address: Pillsbury Winthrop LLP, Intellectual Property Group, 50 Fremont Street, P.O. Box 7880, San Francisco, CA, 94105, US

(21) Appl. No.: 10/032,030

(22) Filed: Dec. 21, 2001

(51) Int. Cl. H04B 5/00

(52) U.S. Cl. 455/41

(57) ABSTRACT

A system and method of monitoring and controlling operation and performance of a remote device or system implement a wireless interface and standardized wireless communication protocols in monitor and control applications. In one embodiment, a system and method of monitoring and controlling a remote device through a wireless interface are operative in accordance with Bluetooth(™) protocol architecture.

### FIELD OF THE INVENTION

Aspects of the present invention relate generally to monitor and control systems, and more particularly to a system and method of implementing wireless communication technologies in monitor and control applications.

### DESCRIPTION OF THE RELATED ART

Conventional data monitoring and process control systems rely upon dedicated wire-lines to enable communication and data transfer between a control system and a remote sensor or actuator device; wire-lines are also necessary for communication between different control subsystems in a larger controlled environment. Dedicated wire-lines typically limit the utility of a remote device or an associated monitor and control system in at least the following respects: acceptable locations for the remote device are generally restricted by the requirement that the remote device have convenient access to the wire-line; and the remote device may respond only to a single control system or apparatus (i.e. that which is connected to the wire-line).

Recent developments in Internet Protocol (IP) communications and in local area networking technology have enabled monitoring and control of various devices and industrial processes from multiple remote locations simultaneously. Myriad manufacturers and disparate control standards, however, often yield devices which are not compatible with each other; devices made by a particular manufacture often can neither communicate with, monitor, nor control equipment made by a different manufacturer. Additionally, devices which have been optimized for monitor and control under the supervision of an operator or administrator, for example, typically require different control interfaces when monitored or controlled automatically by a remote machine. Though recent developments in wireless communication protocols have standardized, to some extent, communication between devices having appropriate wireless communication interfaces, such wireless communication technology has not be implemented in monitor and control applications.

### BRIEF DESCRIPTION OF THE DRAWINGS

FIG. 1 is a simplified block diagram illustrating one embodiment of a monitor and control apparatus which may employ a wireless communication interface and protocol.

FIG. 2 is a simplified block diagram illustrating one embodiment of a wireless monitor and control system.

FIG. 3 is a simplified block diagram illustrating one embodiment of a removable module which may be implemented in conjunction with a wireless monitor and control apparatus.

FIG. 4 is a simplified flow diagram illustrating the general operational flow of one embodiment of a wireless monitor and control method.

FIG. 5 is a simplified flow diagram illustrating the general operational flow of one embodiment of a method of utilizing a monitor and control device having wireless communication capabilities.

### DETAILED DESCRIPTION

Embodiments of the present invention overcome various shortcomings of conventional technology, providing a system and method which employ a wireless interface and implement standardized wireless communication protocols to monitor and to control a remote device. In accordance with one aspect of the present invention, a system and method of monitoring and controlling a remote device employing wireless communication technologies are operative in accordance with Bluetooth(™) protocol architecture.

The foregoing and other aspects of various embodiments of the present invention will be apparent through examination of the following detailed description thereof in conjunction with the accompanying drawings.

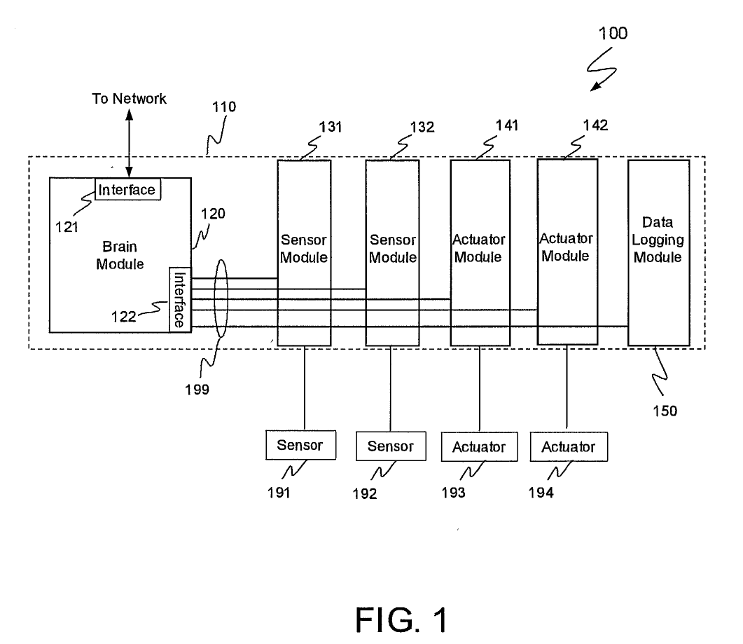

Turning now to the drawings, FIG. 1 is a simplified block diagram illustrating one embodiment of a monitor and control apparatus which may employ a wireless communication interface and protocol. In the exemplary embodiment, apparatus 100 generally comprises a housing or rack 110 accommodating and interconnecting removable modules 120-150. When constructed and operative in accordance with the FIG. 1 embodiment, apparatus 100 may function as an input/output monitoring and data logging device, and may additionally transmit data or provide control signals as set forth in detail below.

As illustrated in FIG. 1, removable modules may include one or more of the following: a control (brain) module 120; one or more data acquisition (sensor) modules 131,132; one or more data transmission (actuator) modules 141,142; and a data logging module 150. For clarity, only two sensor modules 131,132, two actuator modules 141,142, and one data logging module 150 are depicted in FIG. 1. Those of skill in the art will appreciate that the FIG. 1 embodiment is presented for illustrative purposes only, and that apparatus 100 may be implemented with any number of sensor or actuator modules and one or more additional data logging modules.

Apparatus 100 may be constructed and arranged such that insertion of a removable module 120-150 into housing or rack 110 automatically creates necessary electrical and data communication connections via a bus 199, for example, or other communication pathway. Such “plug-and-play” versatility may enable apparatus 100 to perform different functions depending upon the number, type, and particular configuration of removable modules 120-150 coupled to rack 110. As set forth in more detail below, data communication between removable modules 120-150 may be in accordance with any protocol known in the art or developed and operative in accordance with known principles.

By way of example, sensor modules 131,132 and actuator modules 141,142 may include suitable hardware, firmware, software, or a combination thereof operative to transmit and to receive data. As illustrated in FIG. 1, sensor modules 131,132 may generally be configured to monitor the operation of, and to receive data output from, respective sensors 191,192. Sensors 191,192 may be thermistors, thermocouples, or other temperature measuring equipment, tachometers, speedometers, pressure gauges, fluid flow meters, gyroscopes, infrared or motion detectors, acoustic or other audio signal sensors, or any other similar meters, gauges, or indicators capable of generating output which may be monitored by sensor modules 131,132. Where sensors 191,192 provide analog signals, appropriate analog to digital (AID) converters (not shown) may be implemented.

Additionally or alternatively, one or more actuator modules 141,142 may be configured to transmit control signals or other desired data to actuators 193,194. In the FIG. 1 embodiment, actuators 193,194 represent a wide range of equipment and devices such as, for example: control modules embodied in computer hardware or software; computer-based or electronically controlled machinery; servos; hydraulic systems; electronic circuits; and any other devices to be controlled by apparatus 100.

Brain module 120 may be any machine intelligence capable of two-way data communication with modules 131-142 and data logging module 150. In the FIG. 1 embodiment, brain module 120 may additionally be capable of interfacing data received from other components of apparatus 100 with a remote device such as a computer or wireless device (not shown) over a network as set forth in detail below. In operation, brain module 120 may execute computer programs or instructions encoded on a computer-readable medium, for example, to configure modules 131-142 and data logging module 150. Brain module 120 may also execute computer instructions to perform control functions or otherwise to manipulate actuators 193,194 or other remote devices coupled to actuator modules 141,142 as discussed above.

Brain module 120 may generally be configured to control operation of apparatus 100. Such control functionality may be enabled by a programmable logic controller (PLC), for example. Alternatively, brain module 120 may be embodied in a more powerful and versatile hardware arrangement. In that regard, brain module 120 may incorporate a microprocessor or microcontroller based microcomputer and include sufficient communications interfaces (logical and physical layers) to enable the data communication illustrated graphically in FIG. 1; these interfaces are represented by reference numerals 121 and 122, and are described in more detail below. One or more communications interfaces (such as interface 122) may generally be dedicated to communicating with modules 131-150, and one or more communications interfaces (such as interface 121) may generally be dedicated to communicating to other networked devices, such as equipment connected to a Local Area Network (LAN), a Wide Area Network (WAN), a Virtual Private Network (VPN), and the like.

Data logging module 150 may generally be operative to receive and to store data monitored and acquired by sensor modules 131,132. In that regard, data logging module 150 may be operatively coupled with brain module 120 via a two-way data communication link; data logging module 150 may additionally be operatively coupled with one or more modules 131-142 via a similar bi-directional data connection.

In operation, data logging module 150 may receive configuration instructions from brain module 120 specifying monitoring and control parameters for data logging procedures. Through such configuration, data logging module 150 may be instructed regarding which types of data are to be recorded at specified time intervals, for example, or at which data measurement levels an alarm is to be issued. Data logging module 150 may then manage data acquisition and recordation functions in accordance with such configuration instructions. It will be appreciated that data logging module 150 may acquire data either from brain module 120, from modules 131-142 directly, or from a combination thereof, depending upon, for example, the specific configuration instructions received from brain module 120 and the interface between modules 120-150.

In one embodiment mentioned above, an interface between brain module 120 and the other removable modules 131-150 may be integrated, or hard-wired, into housing or rack 110 such that electrical connections and data interfaces (represented in FIG. 1 by bus 199) required for operation of, and bi-directional communication between, modules 120-150 may be made automatically upon insertion into rack 110. By way of example, the data connection may be a serial or parallel link. Alternatively, the data connection may be any type generally known in the art for communicating or transmitting data across a computer network; examples of such networking connections and protocols include, but are not limited to, Transmission Control Protocol/Internet Protocol (TCP/IP), Ethernet, Fiber Distributed Data Interface (FDDI), ARCNET, token bus or token ring networks, Universal Serial Bus (USB), and Institute of Electrical & Electronics Engineers (IEEE) 1394 (typically referred to as FireWire).

Other types of data network interfaces and protocols are within the scope and contemplation of the present disclosure. In particular, brain module 120 may transmit data to, and receive data from, modules 131-150 using wireless data communication techniques, such as infrared (IR) or radio frequency (RF) signals, for example, or other forms of wireless communication. In such a wireless embodiment, brain module 120 and one or more of modules 131-150 may be capable of communicating via the Bluetooth(TM) standard, for example. Those of skill in the art will appreciate that the hardware backplane, or bus 199 (i.e. wire-line data connection), may be supplanted by an RF Personal Area Network (referred to herein by its Bluetooth(™) acronym, PAN).

The foregoing wireless arrangement may employ brain module 120 and associated modules 131-150 as components of an extended monitor and control PAN, which may also include other Bluetooth(™) peripherals; such a wireless PAN arrangement may eliminate the need to employ a physical wire-line connection between brain module 120 and other modules 131-150, providing flexibility and adaptability for a control and monitor system. Additionally, such an embodiment of apparatus 100 may eliminate the need to connect apparatus 100 physically (i.e. via wire-line) to a network.

Accordingly, apparatus 100 may employ one or more bi-directional wireless communication interfaces 121,122 incorporating, for example, appropriate hardware as well as software or other instruction code implemented at brain module 120. Where wireless communication between brain module 120 and other components of apparatus 100 is desired (through interface 122, for example), one or more additional modules 131-150 may similarly include appropriate hardware and software to enable the wireless communication link. Where wireless communication between brain module 120 and a remote device is desired, the wireless communication interface hardware, software, and functionality (represented as interface 121) may be implemented in the brain module 120 itself, as illustrated in FIG. 1; alternatively, hardware and software necessary to support the functionality of interfaces 121,122 may be implemented in a dedicated wireless module as set forth in detail below.

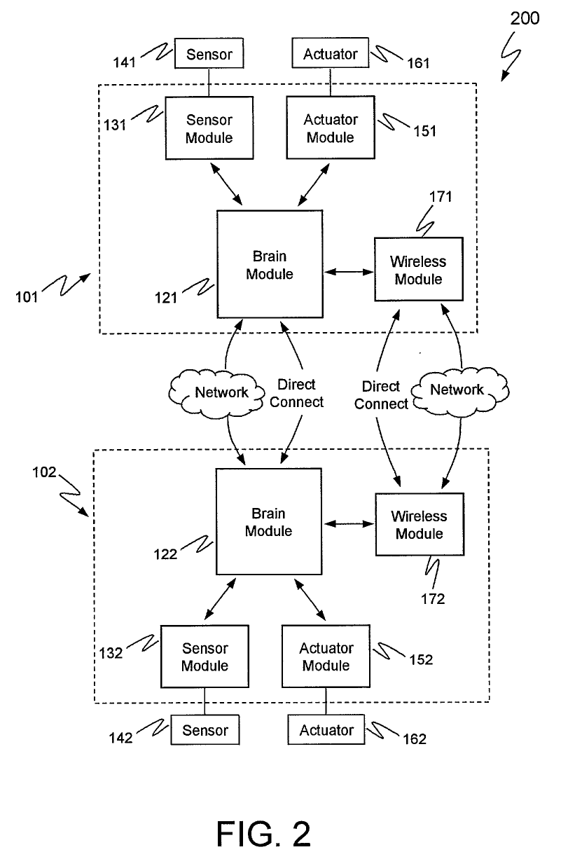

FIG. 2 is a simplified block diagram illustrating one embodiment of a wireless monitor and control system. As illustrated in FIG. 2, a monitor and control system 200 employing a wireless interface and implementing standardized wireless communication protocols may include one or more devices, such as apparatus 101 and 102, for example, which may generally correspond to apparatus 100 described in detail above with reference to FIG. 1, and which may incorporate all of the foregoing functionality. Similarly, the sensors 141,142 and actuators 161,162 depicted in FIG. 2 may generally correspond to sensors 191,192 and actuators 193,194, respectively, discussed above with reference to FIG. 1.

In accordance with one embodiment, a plurality of similar control modules, such as brain modules 121 and 122, for example, may be provided with a wireless network interface component (not shown) enabling two-way wireless data communication. Such an embodiment may enable direct internetworking of a plurality of brain modules 121,122 as illustrated in FIG. 2. Additionally or alternatively, brain modules 121,122 may be indirectly coupled, for example, through a network connection provided by communication with a wireless device or with a wireless telecommunications base station.

Additionally or alternatively, each apparatus 101,102 may further include a respective wireless module 171,172, which may generally correspond to other removable modules 131-150 described above; in the FIG. 2 embodiment, wireless modules 171,172 may include appropriate hardware, firmware, and software components necessary to enable respective brain modules 121,122 to communicate with wireless peripherals, such as Bluetooth(™)-enabled devices, via a wireless network such as a PAN. It will be appreciated that such an arrangement may additionally allow Bluetooth(™)-enabled wireless modules 171,172 to communicate directly as illustrated in FIG. 2, without the assistance or intervention of other devices connected to a PAN, for example.

Wireless modules 171,172 may also incorporate necessary hardware and software to communicate with respective brain modules 121,122. As set forth above with reference to other modules 131-150 illustrated in FIG. 1, such communication may occur via a hard-wired backplane represented by bus 199 in FIG. 1; additionally or alternatively, communication between wireless modules 171,172 and the other modules in each respective apparatus 101,102 may be wireless.

Where not incorporated directly in brain modules 121,122, the hardware and software resident in wireless modules 171,172 may handle the protocol, control, and physical layer functions specified by the Bluetooth(™) protocol stack. Accordingly, the FIG. 2 embodiment may allow communication between the various components of system 200 (incorporating monitor and control apparatus 101,102) and one or more wireless devices, such as Bluetooth(™)-enabled peripheral equipment.

In operation of the FIG. 2 embodiment, a PAN may be established comprising, for example, a Bluetooth(™)-enabled control valve (represented by actuator 161, for instance), which may be networked to a cellular telephone, a portable Personal Digital Assistant (PDA), a remote computer, and the like. The PAN arrangement may facilitate transmission of any available process or operational data, for example, and similar information from any point on system 200, such as from apparatus 101 or 102, to the aforementioned control valve, or to any other peripheral device on the PAN (such as a master, slave, or peer device). Additionally or alternatively, performance characteristics, real-time diagnostic data, and the like may similarly be transmitted from one apparatus 101,102 to any other point on the PAN. Data transmissions may include, but are not limited to, the following: process variables; control signals; formatted text messages; Simple Network Management Protocol (SNMP), Simple Mail Transfer Protocol (SMTP) data, or eXtensible Markup Language (XML) data messages; Wireless Application Protocol (WAP) data; and the like.

As indicated above, brain modules 121,122 may be enabled, by the Bluetooth(™) protocol architecture for example, to communicate with similarly enabled peripheral equipment or devices. It will be appreciated by those of skill in the art that the functionality of a Bluetooth(™) or other wireless interface (including the logical and physical functions of the appropriate protocol stack) may generally be integrated as part of brain modules 121,122, rather than incorporated as part of the functionality of separate wireless modules 171,172.

The foregoing discussion has been provided by way of example only; the present disclosure is not limited to a single wireless protocol or architecture. While the FIG. 2 embodiment has been described with reference to Bluetooth(™), for example, it is within the scope and contemplation of the present disclosure to include other forms of short, medium, and long range wireless networking, including RF embodiments. By way of specific example, embodiments operating in accordance with IEEE 802.11, a wireless LAN protocol, are readily implemented to operate as set forth in detail above.

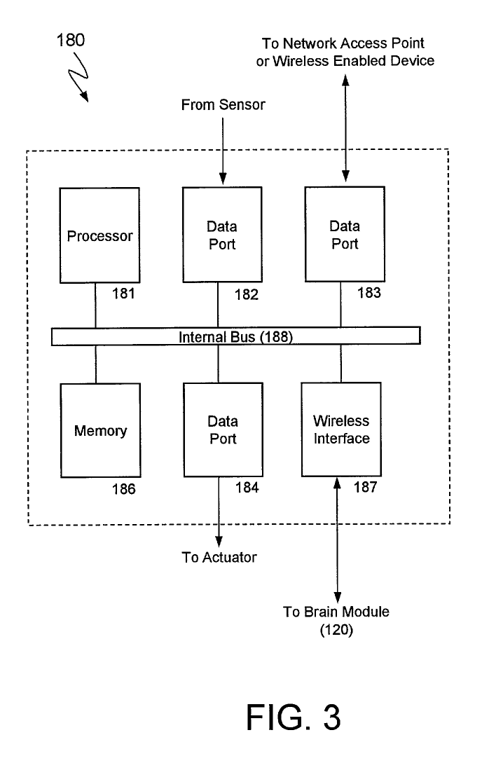

FIG. 3 is a simplified block diagram illustrating one embodiment of a removable module which may be implemented in conjunction with a wireless monitor and control apparatus. Removable module 180 may generally correspond to modules 131-142 and data logging module 150 described above with reference to FIGS. 1 and 2; similarly, module 180 may provide or incorporate the functionality of wireless modules 171,172 described above with reference to FIG. 2. As illustrated in FIG. 3, module 180 may include a processor 181, one or more data ports 182-184, a data storage medium or memory 186, and an interface to a brain module; in the FIG. 3 embodiment, two-way data communication with a brain module is illustrated as enabled by a wireless interface 187, which may operate in accordance with Bluetooth(™). The foregoing components may communicate with each other via an internal bus 188.

Processor 181 may govern operation of removable module 180 in accordance with configuration instructions and assigned operational characteristics; data and instructions necessary to provide processor 181 with required operational parameters may be stored, for example, in memory 186. Additionally or alternatively, processor 181 may receive configuration instructions from an external memory source (through data port 183, for example) or from a brain module as described above (for example, through wireless interface 187).

As an example of an apparatus operating in accordance with a data acquisition embodiment, data port 182 is illustrated as receiving input from a sensor, which may generally correspond to sensors 191,192 described in detail above. In this embodiment, memory 186 may store monitored data received via data port 182 in addition to data and instructions necessary for operation of processor 181. Depending upon its particular configuration, removable module 180 may also transmit such data received via data port 182 to a remote device or system component, either through data port 183 or through wireless interface 187. As indicated in FIG. 3, data port 183 may also allow wireless data communication.

As an example of an apparatus operating in accordance with a data transmission embodiment, data port 184 is illustrated as transmitting control signals or other data to an actuator, which may generally correspond to actuators 193,194 described in detail above. Transmission of data or control signals may affect the functional characteristics of a remote device or effectuate a particular operation, for example. Those of skill in the art will appreciate that, in some embodiments, data received via data port 182 may be transmitted as a control signal via data port 184, either in raw form or subsequent to one or more processing operations executed at processor 181.

It will be appreciated that the hardware arrangement illustrated in FIG. 3 may incorporate or be embodied entirely on a PLC. As is generally known in the art, a PLC is a ladder-logic controller which may be capable of controlling the functionality or operation of a plurality of devices. In some embodiments, processor 181 may comprise a PLC; alternatively, all of the components of removable module 180 may reside in a PLC or may be coupled to a PLC.

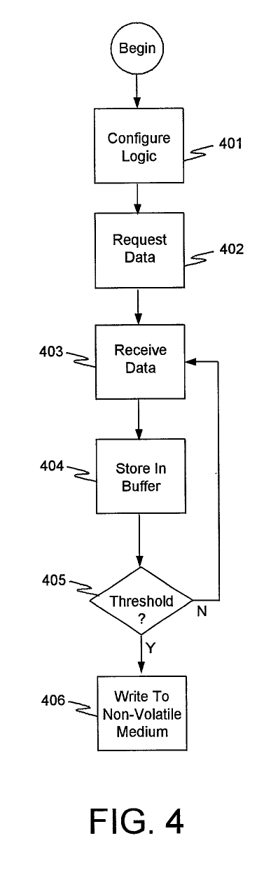

FIG. 4 is a simplified flow diagram illustrating the general operational flow of one embodiment of a data logging method employing a wireless communication protocol. The method depicted in FIG. 4 may be enabled by a system employing one or more sensor modules and a data logging module such as described in detail with reference to FIG. 1. The FIG. 4 embodiment may benefit from the functional capabilities of a wireless module such as described above with reference to FIG. 2.

As indicated at block 401, data logging logic embodied in a data logging module may be configured with instructions related to operational parameters of data monitoring and recordation functions. Logic implemented in hardware which is not programmable may be hardwired (i.e. “preconfigured” during fabrication, for example) to operate in a particular fashion, whereas programmable (i.e. reconfigurable) firmware or software logic may receive configuration instructions from an external source such as the brain module discussed above with reference to FIGS. 1 and 2.

Depending upon the configuration, the data logging module may query one or more system components (such as a sensor module) for data records; such a request for data, indicated at block 402, may generally employ any of the system components and architecture described above with reference to FIGS. 1-3. In an alternative embodiment, a sensor module may be configured to transmit some or all acquired audio data measurements to the data logging module automatically, i.e. independent of a query or request.

As set forth in detail above, the foregoing bidirectional communication between the data logging module and the other system components may implement wireless communication technology and protocols. One or more wireless communication links may employ a removable module such as shown and described with reference to FIG. 3.

Data signals to be logged may be received by the data logging module, via a wireless communication link with a sensor module, as indicated at block 403. Data logging module may store received data in a data buffer (block 404). In some embodiments, instruction code resident in the data logging module may selectively execute one or more data processing operations before directing the received data to storage in the buffer; additionally or alternatively, any computational results derived from received data may also be stored in the buffer. For example, normalization, regression, statistical analysis, and the like, as well and any other appropriate data processing techniques, may be performed by the data logging module prior to directing data to the data buffer at block 404. Alternatively, some or all data may be stored directly into the data buffer without any processing, i.e. in raw form.

Data buffers generally have a limited capacity; a method of logging data may employ buffer monitor circuitry or software code, for example, resident in the data logging module to monitor the amount or volume of data sent to the buffer. When such a buffer monitor determines that the content of the data buffer has reached or exceeded a predetermined threshold (a predetermined value or a predetermined percentage of total capacity, for example), data records stored temporarily in the buffer may be written to a non-volatile data storage medium.

The decision block 405 in FIG. 4 represents the above-described determination. As indicated at block 406, if the buffer contents have reached or exceed the predetermined threshold, data in the buffer may be moved to non-volatile storage. During data logging procedures, while the data content of the buffer has not reached the predetermined threshold, however, the data logging module may continue to receive additional data for storage in the buffer, as indicated by the loop back to block 403.

It will be appreciated that the foregoing method may additionally or alternatively include wire-line or wireless transmission of received data to a remote device. This communication capability may be embodied in the data logging module itself, for example, or provided by other elements of the system such as a wireless module or a brain module as described above. Depending, for example, upon system requirements, network traffic loads, and other factors, transmission of data to a remote device may precede, follow, occur simultaneously with, or entirely replace the sequence of operations depicted in blocks 404-406.

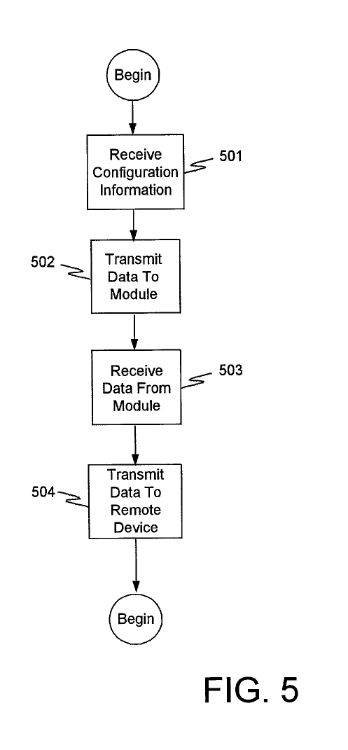

FIG. 5 is a simplified flow diagram illustrating the general operational flow of one method of utilizing a monitor and control device having wireless communication capabilities. The FIG. 5 embodiment may be employed in conjunction with an apparatus such as shown and described in detail above with reference to FIG. 1.

In accordance with the exemplary method, an input/output or monitor and control apparatus may receive data and configuration information as indicated at block 501. As described in detail above, such information may be received from a remote device, such as a computer server or a network client, for example. As is generally known in the art, it may be desirable to configure or to control operation of a networked input/output apparatus from a remote terminal.

In that regard, configuration information or instructions may affect operation of a brain module, for example, or any of the removable modules described above with reference to FIGS. 1-3. In particular, data and configuration information may be relevant to operational parameters, performance characteristics, or the general functionality of one or more modules.

As set forth above, reception of the foregoing configuration information and data or other instructions may be through a wireless interface embodied in appropriate hardware and software incorporated in the input/output apparatus. For example, the wireless interface and its functionality may be integrated into a brain module, or may be coupled to the brain module as an independent, and possibly removable, module. Accordingly, the input/output apparatus need not be physically coupled to a network via a wire-line.

Similarly, the transmission of data to the module (at block 502) may be executed through a wireless interface. For example, the communication interface between brain module 120 and the various other modules 131-150 (FIG. 1) may be wireless, providing flexibility with respect to the location of the input/output apparatus relative to the modules. At block 502, data transmitted to a particular module may include the configuration information received by the apparatus at block 501, for example; additionally or alternatively, data processing may be selectively executed as required prior to transmission to a module. A brain module or PLC, for instance, may interpret configuration instructions received from the remote device, modify data in accordance with firmware or hardware instructions, convert data to a format readable by the module, and the like. Further, in some embodiments, control signals or other data may affect operation of an actuator or other device coupled to a module.

As indicated at block 503, an input/output apparatus may also receive acquired data from a module (e.g. a data acquisition or sensor module), and transmit any acquired data (block 504) to a remote device or network client. As described in detail above, the reception and transmission, at blocks 503 and 504, respectively, of data and any associated instructions may be executed in accordance with a wireless communication protocol through one or more wireless interfaces.

It will be appreciated that various alternatives exist with respect to the FIG. 5 embodiment, and that the presented order of the individual blocks is not intended to imply a specific sequence of operations to the exclusion of other possibilities; the particular application and overall system requirements may dictate the most efficient or desirable sequence of the operations set forth in FIG. 5.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the invention. Therefore, it is intended that the invention be considered as limited only by the scope of the appended claims.

What is claimed is:

1. An apparatus in a monitor and control system; said apparatus comprising:
a control module configured to control operation of said apparatus;
a data acquisition module configured to acquire data from a sensor; and
a bidirectional data communication interface enabling wireless data communication between said control module and said data acquisition module.

2. The apparatus of claim 1 further comprising an additional bidirectional data communication interface enabling wireless data communication between said control module and a remote device.

3. The apparatus of claim 1 further comprising a data transmission module configured to transmit data to an actuator.

4. The apparatus of claim 1 further comprising a data logging module configured to store data acquired by said data acquisition module.

5. The apparatus of claim 1 wherein said control module is operative to transmit configuration instructions to said data acquisition module.

6. The apparatus of claim 3 wherein said bidirectional data communication interface enables wireless data communication between said control module and said data transmission module, and wherein said control module is operative to transmit data signals and configuration instructions to said data transmission module.

7. The apparatus of claim 1 wherein said bidirectional data communication interface operates in accordance with the Bluetooth(™) protocol architecture.

8. The apparatus of claim 2 wherein said additional bidirectional data communication interface operates in accordance with the Bluetooth(™) protocol architecture.

9. The apparatus of claim 2 further comprising a wireless communication module coupled to said control module and comprising said bidirectional data communication interface and said additional bidirectional data communication interface.

10. The apparatus of claim 1 wherein said control module comprises a programmable logic controller configured to communicate with said data acquisition module via said bidirectional interface.

11. A monitor and control system comprising:
an input/output apparatus configured to acquire data from a sensor;
a remote device operable to communicate with said apparatus over a network; and
a wireless communication interface coupled to said apparatus and enabling wireless data communication between said apparatus and said network.

12. The system of claim 11 wherein said apparatus is further configured to transmit data to an actuator.

13. The system of claim 11 wherein said remote device is operable to transmit data and configuration instructions to said apparatus.

14. The system of claim 11 wherein said network is a personal area network.

15. The system of claim 11 wherein said wireless communication interface is embodied in a removable module.

16. The system of claim 11 wherein said apparatus further comprises a programmable logic controller operable to acquire data from a sensor and to transmit data to an actuator.

17. A computer readable medium encoded with data and computer executable instructions for configuring a module implemented in an input/output monitor apparatus; the data and instructions causing a control module executing the instructions to:
receive data and configuration information relevant to an operational configuration of said module from a remote device through a wireless interface; and
transmit said data and configuration information to said module.

18. The computer readable medium of claim 17 further encoded with data and instructions, further causing a control module to transmit said data and configuration information to said module in accordance with a wireless communication protocol through an additional wireless interface.

19. The computer readable medium of claim 17 further encoded with data and instructions, further causing a control module to:
receive acquired data from said module; and
transmit said acquired data and information related to said acquired data to said remote device in accordance with a wireless communication protocol through said wireless interface.

20. A method of utilizing a monitor and control apparatus; said method comprising:
receiving data and configuration information from a remote device through a wireless interface; said data and configuration information being relevant to an operational configuration of a module coupled to said apparatus; and
transmitting said data and configuration information to said module.

21. The method of claim 20 wherein said transmitting comprises selectively transmitting said data and configuration information to said module in accordance with a wireless communication protocol through an additional wireless interface.

22. The method of claim 20 further comprising:
receiving acquired data from said module; and
transmitting said acquired data and information related to said acquired data to said remote device in accordance with a wireless communication protocol through said wireless interface.

23. The method of claim 20 wherein said transmitting comprises providing instructions affecting operation of an actuator coupled to said module.

24. The method of claim 20 wherein said receiving and said transmitting are conducted in accordance with instructions executed by a programmable logic controller.
